(19) United States
(12) Patent Application Publication
(10) Pub. No.: US 2026/0077613 A1
(43) Pub. Date: Mar. 19, 2026

(54) SECURE TRANSACTION OR STORED-VALUE CARD ASSEMBLIES

(71) Applicant: Travel Tags, Inc., North Mankato, MN (US)

(72) Inventor: John Tomcyzk, Shoreview, MN (US)

(21) Appl. No.: 19/329,093

(22) Filed: Sep. 15, 2025

Related U.S. Application Data
(60) Provisional application No. 63/694,573, filed on Sep. 13, 2024.

(51) Int. Cl. B42D 25/378; B42D 25/20; B65D 73/00; G06K 19/06; G06Q 20/26

(52) U.S. Cl. CPC B42D 25/378; B42D 25/285; B65D 73/0007; G06Q 20/26; G06K 19/06028

(57) ABSTRACT

Card assemblies for concealing and protecting activation indicia on the card assembly. Two panels, either discrete or foldable, form the card itself, such as a CR80 card or an M6 card assembly, with or without a CR80 snap-off portion. Activation indicia, such as a barcode, can be printed or otherwise applied to an exterior portion of the card assembly, or printed or otherwise applied to an interior of the assembly which is accessed by a tamper evident pull tab. Redemption indicia, such as an alpha-numeric code, can be applied to an interior surface of the card, which is accessed by a tamper evident pull tab or other tab.

### RELATED APPLICATIONS

This application claims the benefit of Provisional Application No. 63/694,573, filed Sep. 13, 2024, the disclosure of which is hereby incorporated by reference in its entirety.

### TECHNICAL FIELD

This application relates generally to fraud prevention for stored value cards, and more particularly relates to a system used for securing redemption and activation data within a secure package forming the card itself, the system being configured to conceal redemption and activation data of stored value cards with packaging that is to be removed upon purchase.

### BACKGROUND

Stored value cards, which may also be known as gift cards, prepaid cards, reload cards, shopping cards or fare cards, prepaid Mastercard™ and Visa™ cards (instant issue) among other names, are very popular with both consumers and retailers. The wide appeal of stored value cards, as a result, has attracted the unwelcome attention of criminals seeking to exploit the conveniences and automated processes afforded by such cards. In particular, such criminals misappropriate and manipulate stored value cards and associated account information to perform fraudulent transactions. Stored value card fraud is typically perpetrated in the form of either at the physical point of sale (POS) or “card present” fraud, or for virtual POS purchases or “card not present” (CNP) fraud. The latter includes transactions such as in e-commerce or internet purchases that cannot be authenticated using “standard” processes used at the physical POS.

A stored value card is typically the size and shape of a conventional credit card, known in the industry as a CR80 Card, and can include a magnetic stripe, barcode or other similar activation method, account identifying element, or means for using the card. The magnetic stripe, code, account identifying element, etc. on the card is encoded with data, which includes a unique account number. The account activation indicia barcode, for example, may be visible while the card is secured in or secured to packaging, such that the account activation indicia may be used during the purchase and activation of the card.

Commonly, stored value cards are displayed by retailers for purchase by customers. The cards may be stored in an active or inactive state. If stored in an inactive state, the card cannot be used to purchase goods or services until the card has been activated. A customer may have a card activated by bringing a card to a cashier and having the cashier then, for example, swipe the card through a point of sale terminal, which may add value to the card in exchange for payment, or activate value already on the card. In this context, the “swipe” action could involve passing a card (or its packaging) though a magnetic stripe reader/writer; or passing the card or package over a barcode scanner; or putting the card or package in the vicinity of a proximity reader/writer (such as, for example, an NFC (Near Field Communications) or RFID reader/writer), or any other equivalent activation technique. A balance on the card may be maintained within a computer system located at the point of sale or at a remote location. A holder of the stored value card may then use the card to purchase goods and/or services up to the value of the card. These current procedures relating to stored value cards, although providing convenience to consumers, leave the cards vulnerable to criminals.

One particular fraud that is perpetuated by criminals with regard to stored value cards is called “skimming.” Skimming is a serious problem resulting in significant loss to both retailers and consumers and applies to both card present and CNP fraud. To skim a card having a magnetic stripe holding account information, for example, a criminal will purchase a stored value card from a retailer, thereby causing an account associated with the card to become activated. The criminal will then remove additional cards from the store that have not yet been activated and will then alter magnetically stored information on the inactivated cards to match that of the activated card. As such, all of the altered, inactivated cards will have the magnetic information that identifies the account of the originally purchased card. The criminal will then return the altered cards to the store shelf where unsuspecting customers seeking to purchase a stored value card will unknowingly place money into the account of the criminal holding the originally purchased card. The unsuspecting customer may attempt to use their card and will be told that it has no associated value or has a smaller value than thought. The retailer may be able to verify that the customer did not use the value associated with the stored value card, and in the interest of customer service, may restore the value to the customer. In that case, the retailer loses the money. However, in some cases, there may be no way to prove fraud and the customer may lose up to the entire value.

Another type of fraud that is perpetrated by criminals with regard to stored value cards is unauthorized activation. Specifically with secure packaging, activation indicia, such as a barcode, is printed on the card and positioned beneath a perforated pull tab. Account information, such as a PIN or account number, is also on the card and sealed within package. Fraud is perpetrated when a criminal takes a stored value package from a retailer without purchasing the package and card. The criminal will remove the package from the store, access redemption data from the card such as the card number and/or person identification number (PIN) code. The criminal then scratches the numbers from the card, and carefully replacing new information. The criminal then rehangs or replaces the package at the retailer location. The criminal then waits until package is sold by visually checking if pack is still on rack or attempts to check balance online. An unsuspecting customer then purchases the package and activates it, unknowingly placing money into the account of the criminal holding the originally purchased card assembly or with access to the original account information. The unsuspecting customer may attempt to use their card and will be told that it has no associated value or has a smaller value than thought. Also, the customer will not be able to verify the replaced card number with customer service, which delays the fraud process with the retailer, which in turn, allows the criminal more time to utilize the account and spend the value.

Another similar type of unauthorized activation is also perpetrated with regard to stored value cards. As above, activation indicia, such as a barcode, is printed on the card and positioned beneath a perforated pull tab. Account information, such as a PIN or account number, is also on the card and sealed within package. Fraud is perpetrated when a criminal takes two stored value packages from a retailer without purchasing either. The criminal will then carefully opens each pack and copies the activation barcode from a first card of the first package and places the data by some means onto to a second card of the second package, and then carefully reseals the second package. The criminal re-hangs or replaces the second package at the retailer location. The criminal then waits until the second package is sold by visually checking if pack is still on rack or attempts to check balance online for the first card. An unsuspecting customer then purchases the second package and unknowingly activates the stored value card of the first package, unknowingly placing money into the account of the criminal holding the first card. The unsuspecting customer may attempt to use the second card and will be told that it has no associated value or has a smaller value than thought. The criminal will also erase numbers off of the second card to delay the fraud investigation.

Another fraud perpetuated by criminals is carried out by the criminal viewing stored value cards in the store. The criminal writes down the code associated with the particular stored value card (such as a credit card type number) while it is still in the store. In such situations the code is in plain view of the criminal or may be easily viewed without altering the card packaging. Once the criminal has recorded the code, the criminal waits for a period of time, assuming that an unsuspecting customer will purchase and have the card activated during that time. The criminal then periodically checks to see if they are able to make purchases, such as online purchases (CNP fraud), by attempting to use the card code. If the card has been activated by the true purchaser, the criminal will be able to purchase goods online using the activated code, thereby stealing the balance on the card from the true purchaser.

Criminals may perpetuate the above-described frauds or other frauds with regard to stored value cards as they sit on store shelves today. Thus, there is a need for a way to protect such cards and ensure that they have not been tampered with or duplicated prior to purchase or activation by an innocent consumer.

There have been proposals and attempts to reduce the occurrence of fraud associated with stored value cards. For example, modifications to card readers or other parts of the activation process have been proposed, but changing existing systems in such ways involves significant cost. Additional steps have been added to the activation process for some cards, such as steps involving pin numbers and web access. However, additional steps reduce the level of convenience that such cards provide to consumers.

Other attempts at reducing the occurrence of fraud include packaging of the card such that unauthorized tampering with the packaging or card therein is visually evident. Examples of these types of secure packs can include, for example, sealing the card, sensitive information concerning the card, or combinations thereof within a single or multi-panel carrier such that a breach of the package destroys the carrier. However, these packages have been vulnerable to breach by the use of a sharp instrument, such as a razor blade, to slice open the package at its sealed or folded edge, by using a heating device such as a source of dry heat or steam to open the heat-sealed pack, by suspending a pack over a solvent to soften cold glue, or a combination of these methods. The card and/or information are then accessed for skimming purposes, and the package is resealed, without evidence that it has been compromised.

Therefore, there remains a need for a way to prevent fraud relating to stored value cards that is effective, and inexpensive to implement, while at the same time not negating the convenience of stored value cards.

### SUMMARY

Examples of the present disclosure include various configurations of card assemblies for concealing and protecting activation indicia on the card assembly. In some embodiments, two panels, either discrete or foldable, form the card itself, such as a CR80 card. In other embodiments, two panels, either discrete or foldable, form an M6 card assembly, with or without a CR80 snap-off portion. Activation indicia, such as but not limited to a barcode, can be printed or otherwise applied to an exterior portion of the card assembly, or printed or otherwise applied to an interior of the assembly which is accessed by a tamper evident pull tab. Redemption indicia, such as but not limited to an alpha-numeric code, can be applied to an interior surface of the card, which is accessed by a tamper evident pull tab or other tab. The pull tabs can be formed by kiss cuts that do not penetrate an entirety of the panel on which its formed such that it is not visible on the outside of the card assembly until it has been pulled or ruptured. These kiss cuts can be straight, wavy, serrated, or any combination thereof. A perforated line can also be used if it shows evidence of tampering. The pull tab indicates tampering in the event it has been ruptured prior to purchasing.

Panels of the card assemblies can be secured together with any of a variety of adhesives, such as cold adhesive, that is not penetrable by heat. The adhesive is applied by flood coating about a perimeter of the card or bleeding off the edge of the card. In the event a sheet of cards is manufactured in which a plurality of cards are formed in one of the sheets used for the front and back panels, the adhesive is flood coated to cover all of the plurality of cards and all around the perimeter of the cards so that the adhesive is bleeding off all edges of each card. This makes it extremely difficult, if not impossible, to access the internal contents and indicia within the assembly.

In other embodiments, a pressure sealable adhesive is used which can be softened by the application of heat. A color change ink can be printed around the perimeter, in which it is configured to permanently change appearance/color upon the application of heat (heat activated glue) or chemical solvent (in the case of cold glue), thereby indicating potential tampering.

The card is a transaction card such as for example, a gift card, a credit card, a debit card, a loyalty program card, or any of a variety of cards which required activation upon purchase.

The above summary is not intended to describe each illustrated embodiment or every implementation of the subject matter hereof. The figures and the detailed description that follow more particularly exemplify various examples.

### BRIEF DESCRIPTION OF THE FIGURES

Subject matter hereof may be more completely understood in consideration of the following detailed description of various examples in connection with the accompanying figures, in which:

FIG. 1A is an exterior view of a back panel of a stored-value card, according to an example;

FIG. 1B is an interior view of the back panel of FIG. 1A;

FIG. 1C is an exterior view of a front panel of the stored-value card of FIG. 1A;

FIG. 1D is an interior view of the front panel of FIG. 1C;

FIG. 2A is an exterior view of a back panel of a stored-value card, according to another example;

FIG. 2B is an interior view of the back panel of FIG. 2A;

FIG. 2C is an exterior view of a front panel of the stored-value card of FIG. 2A;

FIG. 2D is an interior view of the front panel of FIG. 2C;

FIG. 3A is an exterior view of a back panel of a stored-value card, according to another example;

FIG. 3B is an interior view of the back panel of FIG. 3A;

FIG. 3C is an exterior view of a front panel of the stored-value card of FIG. 3A;

FIG. 3D is an interior view of the front panel of FIG. 3C;

FIG. 4A is an exterior view of a back panel of a stored-value card, according to another example;

FIG. 4B is an interior view of the back panel of FIG. 4A;

FIG. 4C is an exterior view of a front panel of the stored-value card of FIG. 4A;

FIG. 4D is an interior view of the front panel of FIG. 4C;

FIG. 5A is an exterior view of a back panel of a card carrier with snap-off card, according to another example;

FIG. 5B is an interior view of the back panel of FIG. 5A;

FIG. 5C is an exterior view of a front panel of the card carrier of FIG. 5A;

FIG. 5D is an interior view of the front panel of FIG. 5C;

FIG. 6A is an exterior view of a back panel of a card carrier with snap-off card, according to another example;

FIG. 6B is an interior view of the back panel of FIG. 6A;

FIG. 6C is an exterior view of a front panel of the card carrier of FIG. 6A;

FIG. 6D is an interior view of the front panel of FIG. 6C;

FIG. 7A is an exterior view of a back panel of a card carrier, according to another example;

FIG. 7B is an interior view of the back panel of FIG. 7A;

FIG. 7C is an exterior view of a front panel of the card carrier of FIG. 7A;

FIG. 7D is an interior view of the front panel of FIG. 7C;

FIG. 8A is an exterior view of a back panel of a card carrier, according to another example;

FIG. 8B is an interior view of the back panel of FIG. 8A;

FIG. 8C is an exterior view of a front panel of the card carrier of FIG. 8A;

FIG. 8D is an interior view of the front panel of FIG. 8C;

FIG. 9A is an exterior view of a front and back panel of a card carrier, according to another example;

FIG. 9B is an interior view of the front and back panel of FIG. 9A;

FIG. 10A is an exterior view of a front and back panel of a card carrier, according to another example;

FIG. 10B is an interior view of the front and back panel of FIG. 10A;

FIG. 11A is an exterior view of a front and back panel of a card carrier, according to another example;

FIG. 11B is an interior view of the front and back panel of FIG. 11A;

FIG. 12A is an exterior view of a front and back panel of a card carrier, according to another example;

FIG. 12B is an interior view of the front and back panel of FIG. 12A;

FIG. 13A is an exterior view of a front and back panel of a card carrier, according to another example;

FIG. 13B is an interior view of the front and back panel of FIG. 13A;

FIG. 14A is an exterior view of a back panel of a card carrier with snap-off card, according to another example;

FIG. 14B is an interior view of the back panel of FIG. 14A;

FIG. 14C is an exterior view of a front panel of the card carrier of FIG. 14A;

FIG. 14D is an interior view of the front panel of FIG. 14C;

FIG. 15A is an exterior view of a back panel of a card carrier with snap-off card, according to another example;

FIG. 15B is an interior view of the back panel of FIG. 15A;

FIG. 15C is an exterior view of a front panel of the card carrier of FIG. 15A;

FIG. 15D is an interior view of the front panel of FIG. 15C;

FIG. 16A is an interior view of a back panel of a card carrier with snap-off card, according to another example;

FIG. 16B is an interior view of a back panel of a card carrier of FIG. 16A;

FIG. 17A is an interior view of a back panel of a card carrier with snap-off card, according to another example; and

FIG. 17B is an interior view of a back panel of a card carrier of FIG. 17A.

While various examples are amenable to various modifications and alternative forms, specifics thereof have been shown by way of example in the drawings and will be described in detail. It should be understood, however, that the intention is not to limit the claimed inventions to the particular examples described. On the contrary, the intention is to cover all modifications, equivalents, and alternatives falling within the spirit and scope of the subject matter as defined by the claims.

### DETAILED DESCRIPTION

The examples described below are not intended to be exhaustive or to limit the invention to the precise forms disclosed in the following detailed description. Rather the examples are chosen and described so that others skilled in the art may appreciate and understand the entire disclosure.

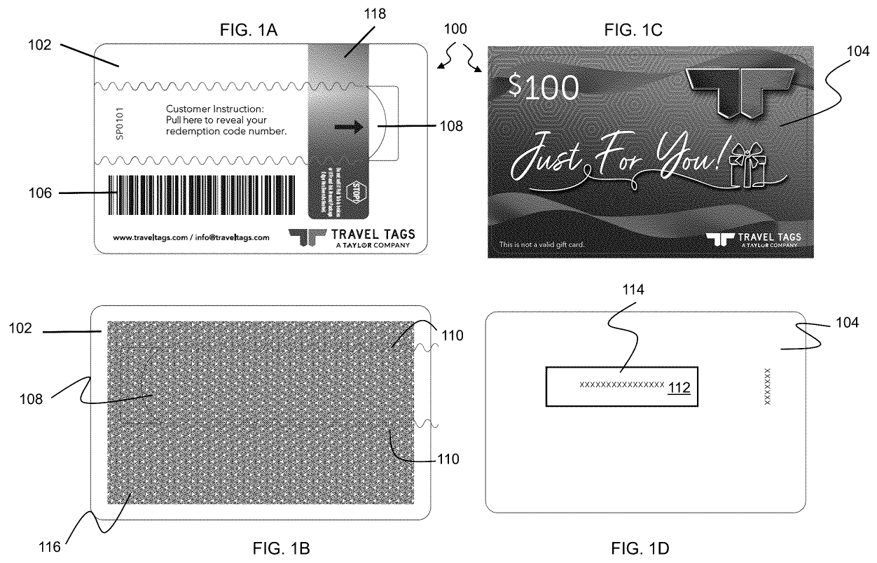

Referring to FIGS. 1A-1D, an exemplary embodiment of a stored value card assembly 100 with tamper evident features is depicted. Assembly 100 can comprise a first back panel 102 and a second front panel 104, each formed of a card stock ranging from about 10-35 point in thickness. Panels 102, 104 can be formed of card stock, paper, laminated paper, or any of a variety of materials known to one skilled in the art. In one non-limiting example, back panel 102 can have a 10-point thickness and front panel can have a 20-21-point thickness for a total of about 30 point thickness, typical of a standard CR80 transaction card. In this embodiment, panels 102 and 104 are discrete panels secured together by adhesive (e.g. hot melt glue, resealable glue, cold glue (e.g. water or solvent based), heat activated glue, UV activated pressure sensitive adhesive (PSA) or adhesive, urethane reactive adhesive, pressure seal (co-hesive), etc.), heat sealing, ultrasonic welding, corresponding physical protrusions (with or without adhesive), any of a variety of sealing means, or combinations thereof. In one particular example, panels 102 and 104 are glued together with cold glue or other adhesive that is flooded around a perimeter of each panel and bleeds off the edge. The card 100 is cut after glue dries. In the event a sheet of cards or assemblies is manufactured in which a plurality of cards are formed in one of the sheets used for the front and back panels, the adhesive is flood coated to cover all of the plurality of cards and all around the perimeter of the cards so that the adhesive is bleeding off all edges of each card. This makes it extremely difficult, if not impossible, to access the internal contents and indicia within the assembly.

For sake of efficiency, these features, including adhesive, materials, or any of the methods of making described can be applied to any of the assemblies described throughout the application.

In this example, as depicted in FIG. 1A, an exterior surface of back panel 102 can include card activation indicia 106 for activating and optionally metering transactions of an account associated therewith. Activation indicia 106 can include barcode encoded or imaged with machine and/or human readable data, a magnetic stripe, an RFID chip, a magnetic stripe encoded or imaged with machine and/or human readable data, or a combination thereof. Back panel 102 further includes structure defining a pull tab 108 formed from kiss cuts 110 visible only on an interior surface of panel 102, which can extend up to about 50% into panel 102. The kiss cuts 110 can form straight lines or can be zig-zagged or serrated as shown.

As shown in FIG. 1D, an interior of inside panel 104 can include a redemption indicia field 112 containing machine- and/or human-readable redemption data 114 or indicia, such as a personal identification number (PIN) or activation code, a bar code, a card sequence number, or combinations thereof. Field 112 is revealed upon rupture of the pull tab 108 at purchase. The redemption indicia 114, if properly entered at purchase, functions to activate the account tied to activation indicia 106.

In order to further secure card 100, as shown in FIG. 1B, an interior of back panel 102 can include a blocking pattern 116 printed or otherwise applied thereon for further obscuring redemption indicia 114. This eliminates the need for a scratch off layer formed over the redemption data 114. An exterior surface of the back panel 102, as shown in FIG. 1A, can further include tamper evident warnings, instructions, and/or other information printed or otherwise applied (e.g. label) thereto. For example, a tamper evident warning 118 can explain that if the pull tab 108 has been ruptured, the card 100 may have been tampered with. As shown in FIG. 1C, an exterior surface of front panel 104 can include any of a variety of text, graphics, information, such as, for example, the source of the card, the amount of a stored-value card, and/or any of a variety of indicia.

Such card 100 can further optionally include any of a variety of features including, but not limited to, an account holder identifying element such as an alphanumeric human and/or machine-readable identifier embossed or printed on one or more of the panels 102, 104, and a signature panel. Optionally, a scratch off layer or label can be applied over certain indicia, such as for concealing a PIN. Again, for sake of efficiency, cards and assemblies identified throughout this application in examples can have any, all, or any combination of these features. Optionally, carrier 100 can include one or more secure glue assist cuts (e.g. confetti cuts) which are formed one or more of the panels. These cuts can be any of a variety of shapes including diamond, crosses, lines, etc. These cuts rupture to indicate tampering when the panels are opened. Optionally, carrier 100 can include terms and conditions either printed directly on carrier 100, such as in the form of a QR code, or glued thereto.

Card 100 has the benefits of being impossible or extremely difficult to reassemble once the pull tab 108 has been removed and shows immediate evidence of tampering. Further, no further secure packaging or scratch off labeling is needed, thereby eliminating materials, while still resembling a secure CR80 card that a consumer is used to.

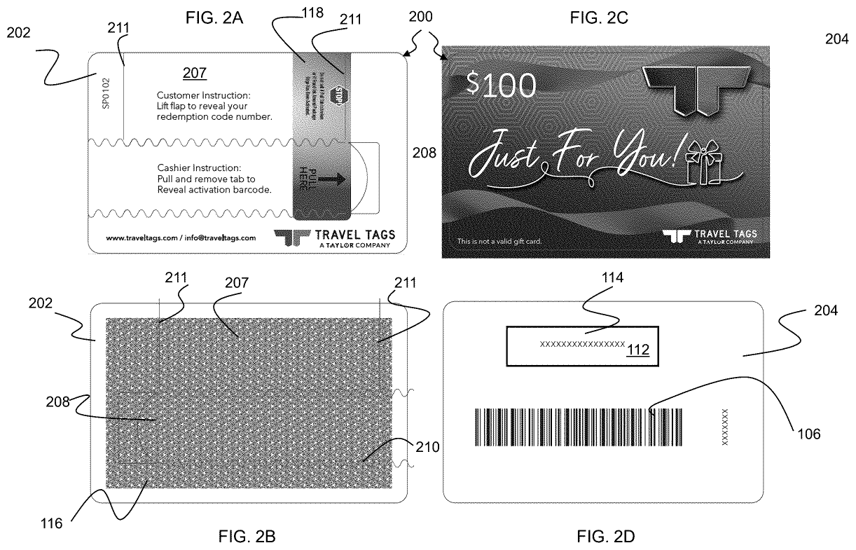

Referring to FIGS. 2A-2D, an exemplary embodiment of a stored value card assembly 200 with tamper evident features is depicted. Assembly 200 includes similar features to assembly 100, except that activation indicia 106, such as a bar code, is printed or otherwise formed on an interior surface of front panel 204, as shown in FIG. 2D, which is covered by pull tab 206. Pull tab 206 is formed as described with respect to assembly 100, and further includes a tab 207 formed by kiss or score cuts 211 (similar to kiss cuts 110, 210) which covers redemption field 112 having redemption data 114 thereon. In this example, pull tab 206 obscures activation indicia 106 until pull tab 206 is ruptured. Once ruptured, tab 207 is lifted up to reveal redemption indicia 114 in redemption field 112.

Similar to assembly 100, an interior of back panel 202 can include a blocking pattern 116 printed or otherwise applied thereon for further obscuring redemption indicia 114. This eliminates the need for a scratch off layer formed over the redemption data 114 and/or activation indicia 106. An exterior surface of the back panel 202, as shown in FIG. 2A, can further include tamper evident warnings, instructions, and/or other information printed or otherwise applied (e.g. label) thereto. For example, a tamper evident warning 118 can explain that if the pull tab 208 and/or tab 207 have been ruptured, the card 200 may have been tampered with. As shown in FIG. 2C, an exterior surface of front panel 204 can include any of a variety of text, graphics, information, such as, for example, the source of the card, the amount of a stored-value card, and/or any of a variety of indicia.

Card 200 has the benefits of being impossible or extremely difficult to reassemble once the pull tab 208 has been removed and shows immediate evidence of tampering. Further, no further secure packaging or scratch off labeling is needed, thereby eliminating materials, while still resembling a secure CR80 card that a consumer is used to.

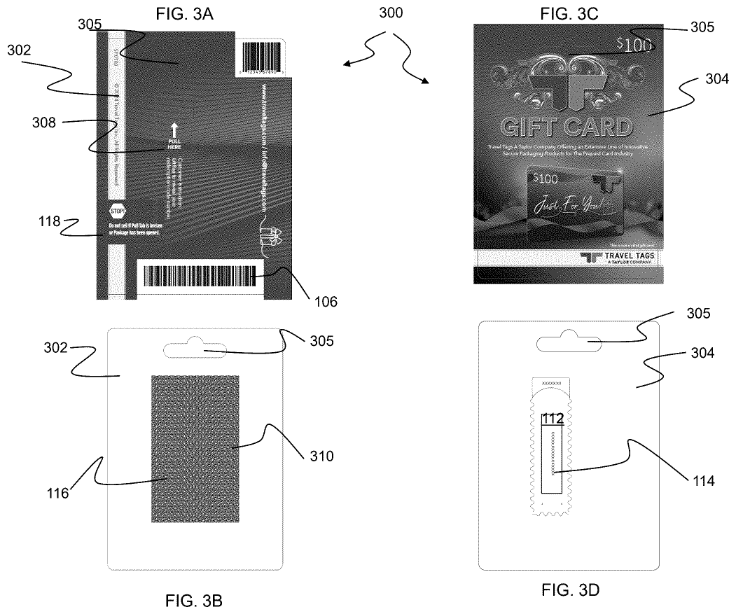

Referring to FIGS. 3A-3D, an exemplary embodiment of a stored value card assembly 300 with tamper evident features is depicted. Assembly 300 includes similar features to assembly 100, except that assembly 300 is in the form of a M6 assembly, including structure defining corresponding hanging aperture 305 formed in each of M6 back panel 302 and M6 front panel 304. In this example, as depicted in FIG. 3A, an exterior surface of back panel 302 can include card activation indicia 106 for activating and optionally metering transactions of an account associated therewith, as described with respect to assembly 100. Back panel 302 further includes structure defining a pull tab 308 formed from kiss cuts 310 visible only on an interior surface of panel 302, as described with respect to assembly 100.

As shown in FIG. 3D, an interior of front panel 304 can include redemption indicia field 112 containing machine- and/or human-readable redemption data 114 as described with respect to assembly 100. Similar to assembly 100, as shown in FIG. 3B, an interior of back panel 302 can include blocking pattern 116 printed or otherwise applied thereon. An exterior surface of the back panel 302, as shown in FIG. 3A, can further include tamper evident warnings 118, instructions, and/or other information printed or otherwise applied (e.g. label) thereto, as described with respect to assembly 100. As shown in FIG. 3C, an exterior surface of front panel 304 can include any of a variety of text, graphics, information, such as, for example, the source of the card, the amount of a stored-value card, and/or any of a variety of indicia.

Card 300 has the benefits of being impossible or extremely difficult to reassemble once the pull tab 308 has been removed and shows immediate evidence of tampering. Further, no further secure packaging or scratch off labeling is needed, thereby eliminating materials, while still resembling a secure M6 card that a consumer is used to when receiving a third-party gift card, for example.

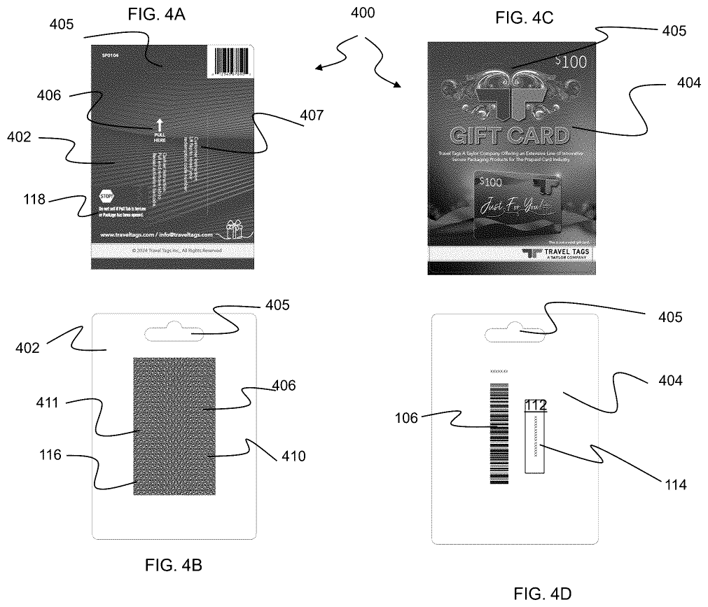

Referring to FIGS. 4A-4D, an exemplary embodiment of a stored value card assembly 400 with tamper evident features is depicted. Assembly 400 includes similar features to assembly 300, including hanging aperture 405, except that activation indicia 106, such as a bar code, is printed or otherwise formed on an interior surface of front panel 404, as shown in FIG. 4D, which is covered by pull tab 406. Pull tab 406 is formed as described with respect to assembly 100, and further includes a tab 407 formed by kiss or score cuts 411 (similar to kiss cuts 410), as described with respect to assembly 200, which covers redemption field 112 having redemption data 114 thereon. In this example, pull tab 406 obscures activation indicia 106 until pull tab 406 is ruptured. Once ruptured, tab 407 is lifted to reveal redemption indicia 114 in redemption field 112.

Similar to assembly 300, an interior of back panel 402 can include a blocking pattern 116 printed or otherwise applied thereon for further obscuring redemption indicia 114. This eliminates the need for a scratch off layer formed over the redemption data 114 and/or activation indicia 106. An exterior surface of the back panel 402, as shown in FIG. 4A, can further include tamper evident warnings, instructions, and/or other information printed or otherwise applied (e.g. label) thereto. For example, a tamper evident warning 118 can explain that if the pull tab 408 and/or tab 407 have been ruptured, the card 400 may have been tampered with. As shown in FIG. 4C, an exterior surface of front panel 404 can include any of a variety of text, graphics, information, such as, for example, the source of the card, the amount of a stored-value card, and/or any of a variety of indicia.

Card 400 has the benefits of being impossible or extremely difficult to reassemble once the pull tab 408 has been removed and shows immediate evidence of tampering. Further, no further secure packaging or scratch off labeling is needed, thereby eliminating materials, while still resembling a secure CR80 card that a consumer is used to.

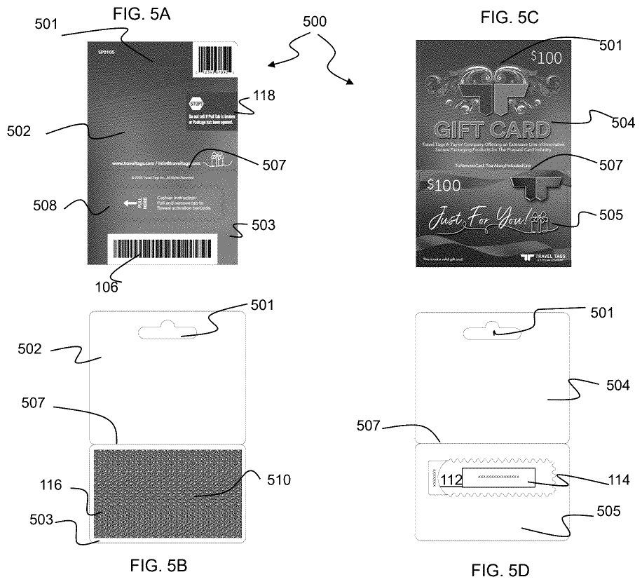

Referring to FIGS. 5A-5D, an exemplary embodiment of a stored value card assembly 500 with tamper evident features is depicted. Assembly 500 includes similar features to assembly 300, and is in the form of a M6 assembly, including structure defining corresponding hanging aperture 501 formed in each of M6 back panel 502 and M6 front panel 504. Unlike assembly 300, assembly 500 also includes snap-off portion 503 on back panel 502 and corresponding snap-off portion 505 on front panel 504, each of which is separated from the respective panel by perforation 507 or score line. Snap-off portions 503, 505 together form a standard CR80 stored value care.

In this example, as depicted in FIG. 5A, an exterior surface of snap-off portion 503 of back panel 502 can include card activation indicia 106 for activating and optionally metering transactions of an account associated therewith, as described with respect to assembly 500. Snap-off portion 503 of back panel 502 further includes structure defining a pull tab 508 formed from kiss cuts 510 visible only on an interior surface of panel 502, as described with respect to assembly 100.

As shown in FIG. 5D, an interior of snap-off portion 505 of front panel 504 can include redemption indicia field 112 containing machine- and/or human-readable redemption data 114 as described with respect to assembly 100. Similar to assembly 100, as shown in FIG. 5B, an interior of snap-off portion 503 of back panel 502 can include blocking pattern 116 printed or otherwise applied thereon. An exterior surface of the back panel 502, as shown in FIG. 5A, can further include tamper evident warnings 118, instructions, and/or other information printed or otherwise applied (e.g. label) thereto, as described with respect to assembly 100, on snap-off portion 503 and/or the remaining portion of back panel 502. As shown in FIG. 5C, an exterior surface of front panel 504 can include any of a variety of text, graphics, information, such as, for example, the source of the card, the amount of a stored-value card, and/or any of a variety of indicia on snap-off portion 505 and/or the remaining portion of front panel 504.

Card 500 has the benefits of being impossible or extremely difficult to reassemble once the pull tab 508 has been removed and shows immediate evidence of tampering. Further, no further secure packaging or scratch off labeling is needed, thereby eliminating materials, while still resembling a secure M6 assembly with snap-off CR80 card that a consumer is used to when receiving a third-party gift card, for example.

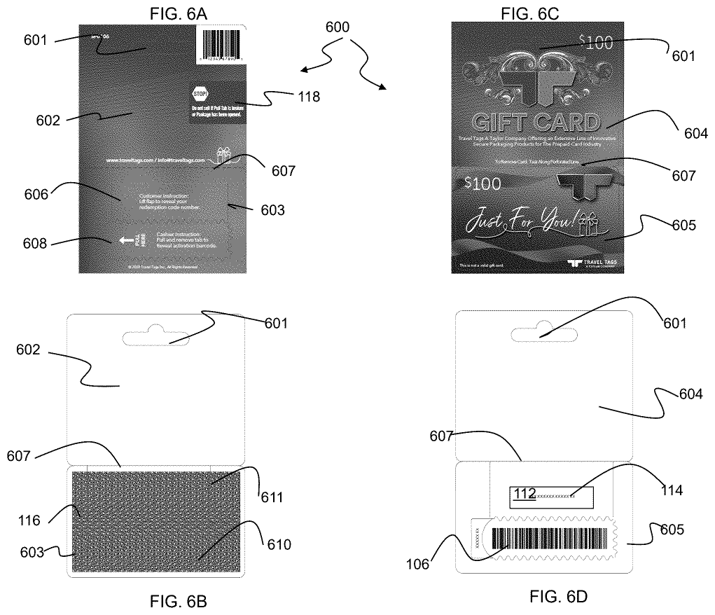

Referring to FIGS. 6A-6D, an exemplary embodiment of a stored value card assembly 600 with tamper evident features is depicted. Assembly 600 includes similar features to assembly 500, including hanging aperture 601 and snap-off portions 603, 605 separated from panels 602, 604, respectively, by perforations 607. Unlike assembly 500, activation indicia 106, such as a bar code, is printed or otherwise formed on an interior surface snap-off portion 605 of front panel 604, as shown in FIG. 6D, which is covered by pull tab 608. Pull tab 608 is formed as described with respect to assembly 100, and further includes a tab 606 formed by kiss or score cuts 611 (similar to kiss cuts 610), as described with respect to assembly 200, which covers redemption field 112 having redemption data 114 thereon. In this example, pull tab 608 obscures activation indicia 106 until pull tab 608 is ruptured. Once ruptured, tab 606 is lifted to reveal redemption indicia 114 in redemption field 112.

Similar to assembly 500, an interior of back panel 602 can include a blocking pattern 116 printed or otherwise applied thereon for further obscuring redemption indicia 114. This eliminates the need for a scratch off layer formed over the redemption data 114 and/or activation indicia 106. An exterior surface of the back panel 602, as shown in FIG. 6A, can further include tamper evident warnings, instructions, and/or other information printed or otherwise applied (e.g. label) thereto, on snap-off portion 603 and/or the remaining portion of back panel 602. For example, a tamper evident warning 118 can explain that if the pull tab 608 and/or tab 606 have been ruptured, the card 600 may have been tampered with. As shown in FIG. 6C, an exterior surface of front panel 604 can include any of a variety of text, graphics, information, such as, for example, the source of the card, the amount of a stored-value card, and/or any of a variety of indicia, on snap-off portion 605 and/or the remaining portion of front panel 604.

Card 600 has the benefits of being impossible or extremely difficult to reassemble once the pull tab 608 has been removed and shows immediate evidence of tampering. Further, no further secure packaging or scratch off labeling is needed, thereby eliminating materials, while still resembling a secure CR80 card that a consumer is used to.

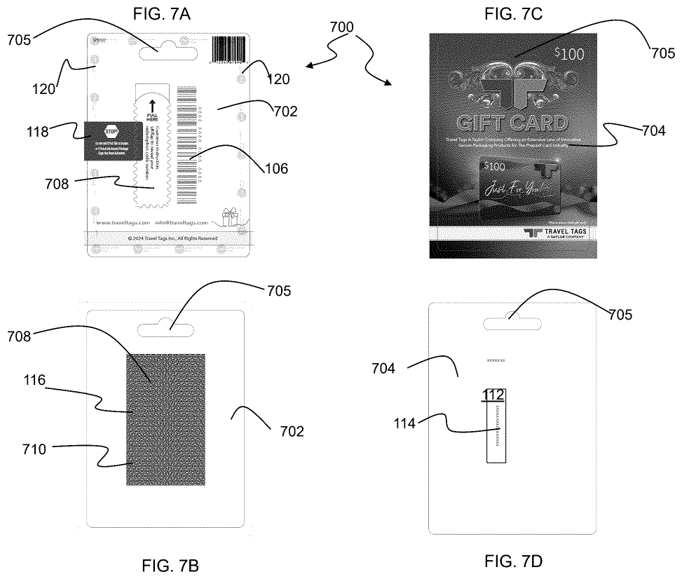

Referring to FIGS. 7A-7D, an exemplary embodiment of a stored value card assembly 700 with tamper evident features is depicted. Assembly 700 includes similar features to assembly 300, including structure defining corresponding hanging aperture 705 formed in each of M6 back panel 702 and M6 front panel 704. In this example, as depicted in FIG. 7A, an exterior surface of back panel 302 can include card activation indicia 706 for activating and optionally metering transactions of an account associated therewith, as described with respect to assembly 100. Back panel 702 further includes structure defining a pull tab 708 formed from kiss cuts 710 visible only on an interior surface of panel 702, as described with respect to assembly 100.

As shown in FIG. 7D, an interior of front panel 704 can include redemption indicia field 112 containing machine- and/or human-readable redemption data 114 as described with respect to assembly 100. Similar to assembly 100, as shown in FIG. 7B, an interior of back panel 702 can include blocking pattern 116 printed or otherwise applied thereon. An exterior surface of the back panel 702, as shown in FIG. 7A, can further include tamper evident warnings 118, instructions, and/or other information printed or otherwise applied (e.g. label) thereto, as described with respect to assembly 100. As shown in FIG. 3C, an exterior surface of front panel 304 can include any of a variety of text, graphics, information, such as, for example, the source of the card, the amount of a stored-value card, and/or any of a variety of indicia.

In this example, unlike assembly 300, in which panels 302, 304 are secured together via a cold glue flooded around the perimeter that cannot be penetrated by heat, panels 702, 704 are secured via a pressure seal glue that can be softened by heat. The perimeter of exterior of back panel 702 is printed with a color change ink 120 or other medium that changes color or appearance upon the application of heat. As shown in FIG. 7A, color change ink 120 changes color to provide a permanent warning or instruction to a potential purchaser to not activate.

Card 700 has the benefits of being impossible or extremely difficult to reassemble once the pull tab 708 has been removed and/or heat applied and shows immediate evidence of tampering. Further, no further secure packaging or scratch off labeling is needed, thereby eliminating materials, while still resembling a secure M6 card that a consumer is used to when receiving a third-party gift card, for example.

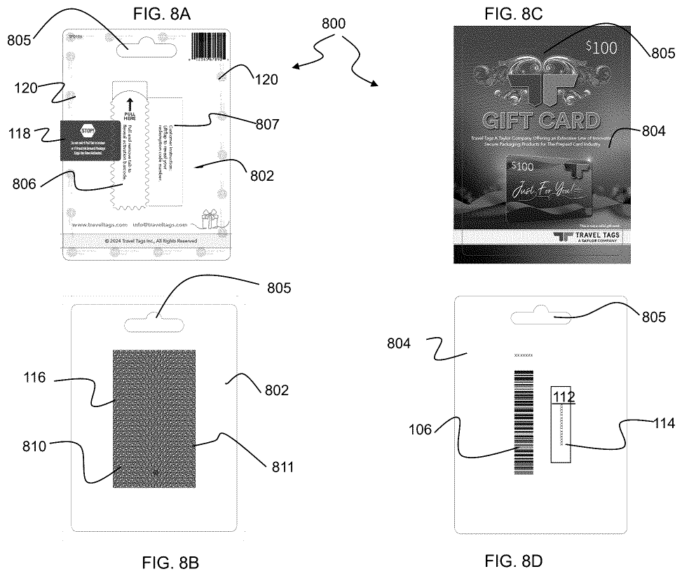

Referring to FIGS. 8A-8D, an exemplary embodiment of a stored value card assembly 800 with tamper evident features is depicted. Assembly 800 includes similar features to assembly 700, including hanging aperture 801 and color change ink 120 printed around the perimeter of back panel 802, except that activation indicia 106, such as a bar code, is printed or otherwise formed on an interior surface of front panel 804, as shown in FIG. 8D, which is covered by pull tab 806. Pull tab 806 is formed as described with respect to assembly 100, and further includes a tab 807 formed by kiss or score cuts 811 (similar to kiss cuts 110), as described with respect to assembly 200, which covers redemption field 112 having redemption data 114 thereon. In this example, pull tab 806 obscures activation indicia 106 until pull tab 406 is ruptured. Once ruptured, tab 807 is lifted to reveal redemption indicia 114 in redemption field 112.

Like assembly 700, an interior of back panel 802 can include a blocking pattern 116 printed or otherwise applied thereon for further obscuring redemption indicia 114. This eliminates the need for a scratch off layer formed over the redemption data 114 and/or activation indicia 106. An exterior surface of the back panel 802, as shown in FIG. 8A, can further include tamper evident warnings, instructions, and/or other information printed or otherwise applied (e.g. label) thereto. For example, a tamper evident warning 118 can explain that if the pull tab 808 and/or tab 807 have been ruptured, the card 800 may have been tampered with. As shown in FIG. 8C, an exterior surface of front panel 804 can include any of a variety of text, graphics, information, such as, for example, the source of the card, the amount of a stored-value card, and/or any of a variety of indicia.

In this example, unlike assembly 400, in which panels 402, 404 are secured together via a cold glue flooded around the perimeter that cannot be penetrated by heat, panels 802, 804 are secured via a pressure seal glue that can be softened by heat. The perimeter of exterior of back panel 802 is printed with a color change ink 120 or other medium that changes color or appearance upon the application of heat. As shown in FIG. 8A, color change ink 120 changes color to provide a permanent warning or instruction to a potential purchaser to not activate.

Card 800 has the benefits of being impossible or extremely difficult to reassemble once the pull tab 808 has been removed and/or heat applied and shows immediate evidence of tampering. Further, no further secure packaging or scratch off labeling is needed, thereby eliminating materials, while still resembling a secure M6 card that a consumer is used to when receiving a third-party gift card, for example.

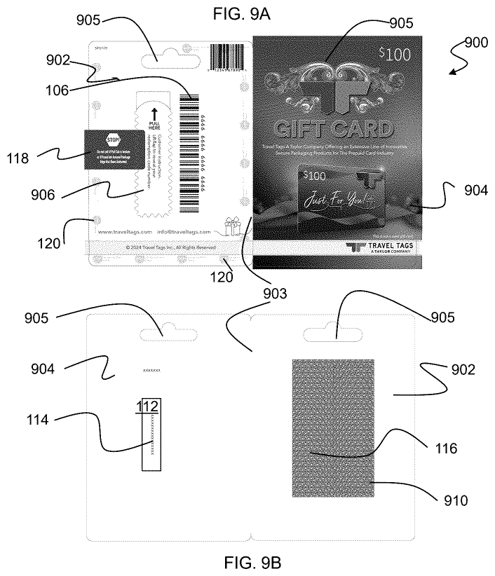

Referring now to FIGS. 9A and 9B, an exemplary embodiment of a stored value card assembly 900 with tamper evident features is depicted. Assembly 900 includes similar features to assembly 700, including structure defining corresponding hanging aperture 905 formed in each of M6 back panel 902 and M6 front panel 904. In this example, unlike assembly 700, in which discrete panels 702, 704 are secured together via a pressure seal glue that can be softened by heat, assembly 900 includes panels 902 and 904 separated by a fold line 903. For assembly, panels 902, 904 are folded over such that the interior surfaces of 902, 904 are adjacent, and panels 902, 904 are secured with a pressure seal glue that is flooded around the perimeter of the card.

In this example, as depicted in FIG. 9A, like assembly 700, an exterior surface of back panel 902 can include card activation indicia 106 for activating and optionally metering transactions of an account associated therewith, as described with respect to assembly 100. Back panel 902 further includes structure defining a pull tab 908 formed from kiss cuts 910 visible only on an interior surface of panel 902, as described with respect to assembly 100.

As shown in FIG. 9B, an interior of front panel 904 can include redemption indicia field 112 containing machine- and/or human-readable redemption data 114 as described with respect to assembly 100. Similar to assembly 100, as shown in FIG. 9B, an interior of back panel 902 can include blocking pattern 116 printed or otherwise applied thereon. An exterior surface of the back panel 902, as shown in FIG. 9A, can further include tamper evident warnings 118, instructions, and/or other information printed or otherwise applied (e.g. label) thereto, as described with respect to assembly 100. As shown in FIG. 9A, an exterior surface of front panel 904 can include any of a variety of text, graphics, information, such as, for example, the source of the card, the amount of a stored-value card, and/or any of a variety of indicia.

In this example, like assembly 700, the perimeter of exterior of back panel 902 is printed with a color change ink 120 or other medium that changes color or appearance upon the application of heat. As shown in FIG. 9A, color change ink 120 changes color to provide a permanent warning or instruction to a potential purchaser to not activate.

Card 900 has the benefits of being impossible or extremely difficult to reassemble once the pull tab 908 has been removed and/or heat applied and shows immediate evidence of tampering. Further, no further secure packaging or scratch off labeling is needed, thereby eliminating materials, while still resembling a secure M6 card that a consumer is used to when receiving a third-party gift card, for example.

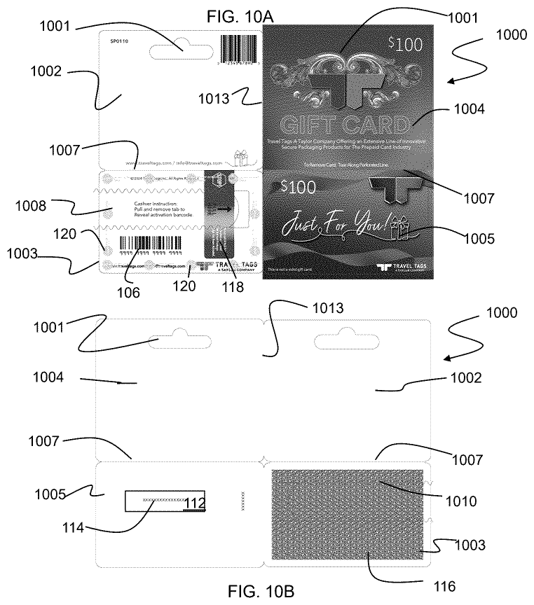

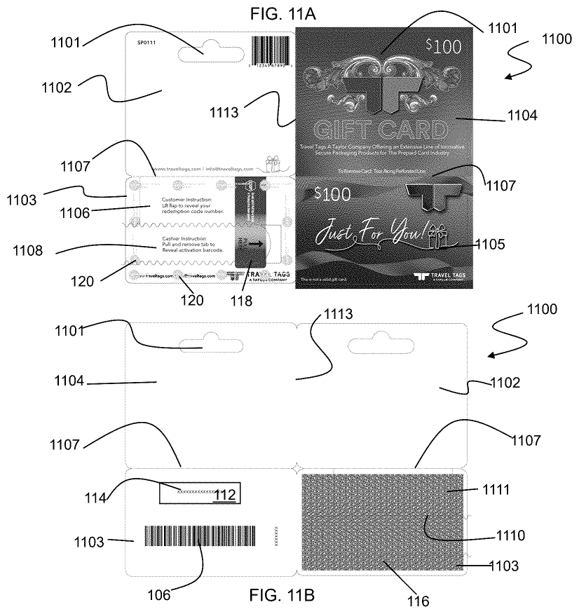

Referring to FIGS. 10A and 10B, an exemplary embodiment of a stored value card assembly 1000 with tamper evident features is depicted. Assembly 1000 includes similar features to assembly 500, and is in the form of a M6 assembly, including structure defining corresponding hanging aperture 1001 formed in each of M6 back panel 1002 and M6 front panel 1004. Like assembly 500, assembly 1000 also includes snap-off portion 1003 on back panel 1002 and corresponding snap-off portion 1005 on front panel 1004, each of which is separated from the respective panel by perforation 1007 or score line. Snap-off portions 1003, 1005 together form a standard CR80 stored value care.

In this example, unlike assembly 500, in which discrete panels 502, 504 are secured together via a cold glue that cannot be softened by heat, assembly 1000 includes panels 1002 and 1004 separated by a fold line 1013. For assembly, panels 1002, 1004 are folded over such that the interior surfaces of 1002, 1004 are adjacent, and panels 1002, 1004 are secured with a pressure seal glue that is flooded around the perimeter of the card.

In this example, as depicted in FIG. 10A, an exterior surface of snap-off portion 1003 of back panel 1002 can include card activation indicia 106 for activating and optionally metering transactions of an account associated therewith, as described with respect to assembly 100. Snap-off portion 1003 of back panel 1002 further includes structure defining a pull tab 1008 formed from kiss cuts 1010 visible only on an interior surface of panel 1002, as described with respect to assembly 100.

As shown in FIG. 10B, an interior of snap-off portion 1005 of front panel 1004 can include redemption indicia field 112 containing machine- and/or human-readable redemption data 114 as described with respect to assembly 100. Similar to assembly 100, as shown in FIG. 10B, an interior of snap-off portion 1003 of back panel 1002 can include blocking pattern 116 printed or otherwise applied thereon. An exterior surface of the back panel 1002, as shown in FIG. 10A, can further include tamper evident warnings 118, instructions, and/or other information printed or otherwise applied (e.g. label) thereto, as described with respect to assembly 100, on snap-off portion 1003 and/or the remaining portion of back panel 1002. As shown in FIG. 10A, an exterior surface of front panel 1004 can include any of a variety of text, graphics, information, such as, for example, the source of the card, the amount of a stored-value card, and/or any of a variety of indicia on snap-off portion 1005 and/or the remaining portion of front panel 1004.

In this example, like assembly 700, the perimeter of exterior of back panel 1002 is printed with a color change ink 120 or other medium that changes color or appearance upon the application of heat. As shown in FIG. 10A, color change ink 120 changes color to provide a permanent warning or instruction to a potential purchaser to not activate.

Card 1000 has the benefits of being impossible or extremely difficult to reassemble once the pull tab 1008 has been removed and shows immediate evidence of tampering. Further, no further secure packaging or scratch off labeling is needed, thereby eliminating materials, while still resembling a secure M6 assembly with snap-off CR80 card that a consumer is used to when receiving a third-party gift card, for example.

Referring to FIGS. 11A and 11B, an exemplary embodiment of a stored value card assembly 1100 with tamper evident features is depicted. Assembly 1100 includes similar features to assembly 1000, and is in the form of a M6 assembly, including structure defining corresponding hanging aperture 1101 formed in each of M6 back panel 1102 and M6 front panel 1104. Like assembly 1000, assembly 1100 also includes snap-off portion 1103 on back panel 1102 and corresponding snap-off portion 1105 on front panel 1104, each of which is separated from the respective panel by perforation 1107 or score line. Snap-off portions 1103, 1105 together form a standard CR80 stored value care.

In this example, like assembly 1000, assembly 1100 includes panels 1102 and 1104 separated by a fold line 1113. For assembly, panels 1102, 1104 are folded over such that the interior surfaces of 1102, 1104 are adjacent, and panels 1102, 1104 are secured with a pressure seal glue that is flooded around the perimeter of the card.

In this example, as depicted in FIG. 11B, unlike assembly 1000, activation indicia 106, such as a bar code, is printed or otherwise formed on an interior surface snap-off portion 1105 of front panel 1104, which is covered by pull tab 1108. Pull tab 1108 is formed of kiss cuts 1110 visible only on an interior surface of panel 1102 as described with respect to assembly 100, and further includes a tab 1106 formed by kiss or score cuts 1111 (similar to kiss cuts 1110), as described with respect to assembly 200, which covers redemption field 112 having redemption data 114 thereon. In this example, pull tab 1108 obscures activation indicia 106 until pull tab 1108 is ruptured. Once ruptured, tab 1106 is lifted to reveal redemption indicia 114 in redemption field 112.

As shown in FIG. 11B, an interior of snap-off portion 1105 of front panel 1104 can include redemption indicia field 112 containing machine- and/or human-readable redemption data 114 as described with respect to assembly 100. Similar to assembly 100, as shown in FIG. 11B, an interior of snap-off portion 1103 of back panel 1102 can include blocking pattern 116 printed or otherwise applied thereon. An exterior surface of the back panel 1102, as shown in FIG. 11A, can further include tamper evident warnings 118, instructions, and/or other information printed or otherwise applied (e.g. label) thereto, as described with respect to assembly 100, on snap-off portion 1103 and/or the remaining portion of back panel 1102. As shown in FIG. 10A, an exterior surface of front panel 1104 can include any of a variety of text, graphics, information, such as, for example, the source of the card, the amount of a stored-value card, and/or any of a variety of indicia on snap-off portion 1105 and/or the remaining portion of front panel 1104.

In this example, like assembly 700 and 1000, the perimeter of exterior of back panel 1102 is printed with a color change ink 120 or other medium that changes color or appearance upon the application of heat. As shown in FIG. 11A, color change ink 120 changes color to provide a permanent warning or instruction to a potential purchaser to not activate.

Card 1100 has the benefits of being impossible or extremely difficult to reassemble once the pull tab 1108 has been removed and shows immediate evidence of tampering. Further, no further secure packaging or scratch off labeling is needed, thereby eliminating materials, while still resembling a secure M6 assembly with snap-off CR80 card that a consumer is used to when receiving a third-party gift card, for example.

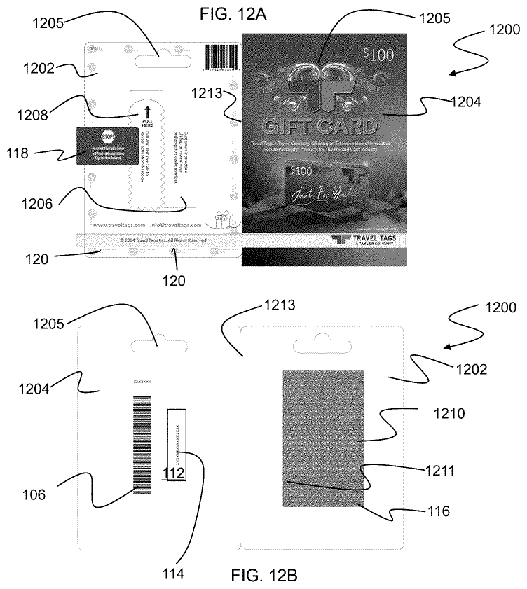

Referring now to FIGS. 12A and 12B, an exemplary embodiment of a stored value card assembly 1200 with tamper evident features is depicted. Assembly 1200 includes similar features to assembly 900, including structure defining corresponding hanging aperture 1205 formed in each of M6 back panel 1202 and M6 front panel 1204. In this example, like assembly 900, assembly 1200 includes panels 1202 and 1204 separated by a fold line 1213. For assembly, panels 1202, 1204 are folded over such that the interior surfaces of 1202, 1204 are adjacent, and panels 1202, 1204 are secured with a pressure seal glue that is flooded around the perimeter of the card.

In this example, as depicted in FIG. 12B, unlike assembly 900, activation indicia 106, such as a bar code, is printed or otherwise formed on an interior surface of front panel 1204, which is covered by pull tab 1208 formed in back panel 1202. Pull tab 1208 is formed of kiss cuts 1210 visible only on an interior surface of panel 1202 as described with respect to assembly 100, and further includes a tab 1206 formed by kiss or score cuts 1211 (similar to kiss cuts 1210), as described with respect to assembly 200, which covers redemption field 112 having redemption data 114 thereon. In this example, pull tab 1208 obscures activation indicia 106 until pull tab 1208 is ruptured. Once ruptured, tab 1206 is lifted to reveal redemption indicia 114 in redemption field 112.

As shown in FIG. 12B, an interior of front panel 1204 can include redemption indicia field 112 containing machine- and/or human-readable redemption data 114 as described with respect to assembly 100. Similar to assembly 100, as shown in FIG. 12B, an interior of back panel 1202 can include blocking pattern 116 printed or otherwise applied thereon. An exterior surface of the back panel 1202, as shown in FIG. 12A, can further include tamper evident warnings 118, instructions, and/or other information printed or otherwise applied (e.g. label) thereto, as described with respect to assembly 100. As shown in FIG. 12A, an exterior surface of front panel 1204 can include any of a variety of text, graphics, information, such as, for example, the source of the card, the amount of a stored-value card, and/or any of a variety of indicia.

In this example, like assembly 700 and 900, the perimeter of exterior of back panel 1202 is printed with a color change ink 120 or other medium that changes color or appearance upon the application of heat. As shown in FIG. 12A, color change ink 120 changes color to provide a permanent warning or instruction to a potential purchaser to not activate.

Card 1200 has the benefits of being impossible or extremely difficult to reassemble once the pull tab 1208 has been removed and/or heat applied and shows immediate evidence of tampering. Further, no further secure packaging or scratch off labeling is needed, thereby eliminating materials, while still resembling a secure M6 card that a consumer is used to when receiving a third-party gift card, for example.

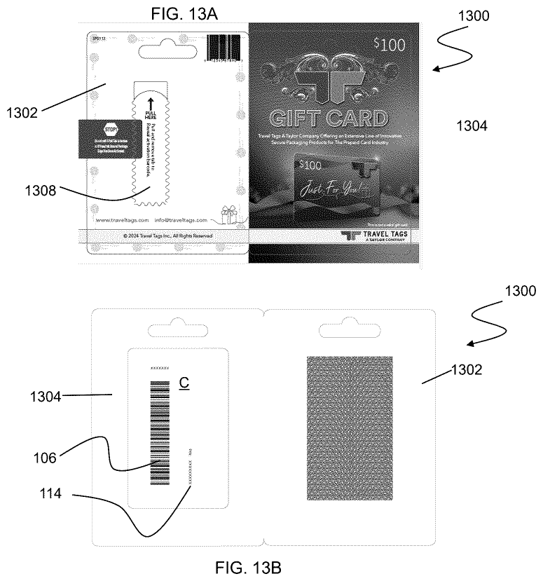

Referring to FIGS. 13A and 13B, an exemplary embodiment of a stored value card assembly 1300 with tamper evident features. Assembly 1300 includes similar features to assembly 1200, except that instead of activation indicia and redemption code on the assembly itself, a card C, such as a CR80 card with activation indicia thereon, is coupled to panel 1304 and sandwiched between panels 1302, 1304. Rupturing of pull tab 1308 reveals the activation indicia 116 and redemption code 114 on the card C.

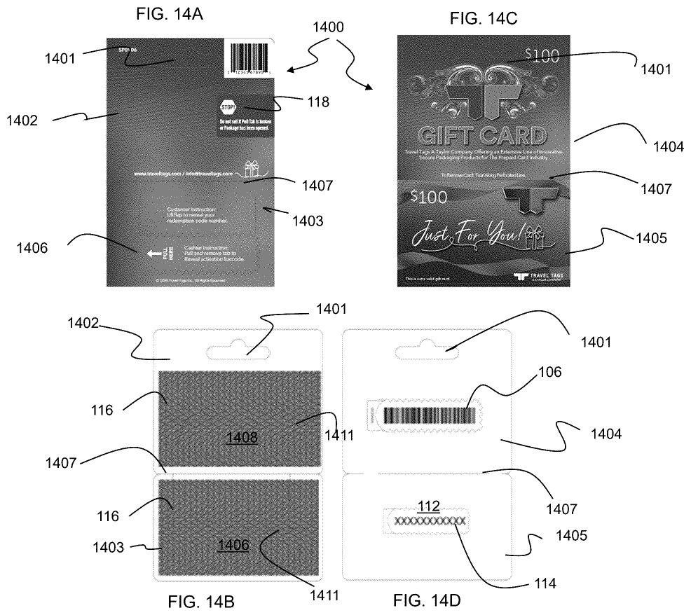

Referring to FIGS. 14A-14D, an exemplary embodiment of a stored value card assembly 1400 with tamper evident features is depicted. Assembly 1400 includes similar features to assembly 600, including hanging aperture 1401 and back and front snap-off portions 1403, 1405 separated from back and front panels 1402, 1404, respectively, by perforations 1407. Activation indicia 106, such as a bar code, is printed or otherwise formed on an interior surface of front panel 1404, as shown in FIG. 14D, under pull tab 1408 formed in panel 1402. Assembly 1400 further includes a second pull tab 1406 formed in snap off portion 1403 which covers redemption field 112 having redemption data 114, such as a PIN code, printed on or applied to portion 1405. Pull tabs 1406 and 1408 are formed as described with respect to the other assemblies, and are formed by kiss or score cuts 1411 (similar to kiss cuts 210 as described with respect to assembly 200, for example), In this example, pull tab 1408 obscures activation indicia 106 until pull tab 1408 is ruptured, and pull tab 1406 obscures redemption indicia 114 in redemption field 112 until pull tab 1406 is ruptured.

As shown in FIG. 14B, an interior of both back panel 1402 and snap-off portion 1403 can include a blocking pattern 116 printed or otherwise applied thereon for further obscuring redemption indicia 114 and activation indicia 106. This eliminates the need for a scratch off layer formed over the redemption data 114 and/or activation indicia 106. An exterior surface of the back panel 1402, as shown in FIG. 14A, can further include tamper evident warnings, instructions, and/or other information printed or otherwise applied (e.g. label) thereto, on snap-off portion 1403 and/or the remaining portion of back panel 1402. For example, a tamper evident warning 118 can explain or warn that if the pull tab 1408 and/or tab 1406 have been ruptured, the assembly 1400 may have been tampered with. As shown in FIG. 14C, an exterior surface of front panel 1404 can include any of a variety of text, graphics, information, such as, for example, the source of the card, the amount of a stored-value card, and/or any of a variety of indicia, on snap-off portion 1405 and/or the remaining portion of front panel 1404. After assembly 1400 is activated, the top panels 1402 and 1404 can be removed, leaving the bottom snap-off portions 1403, 1405 as a giftable card.

Assembly 1400 has the benefits of being impossible or extremely difficult to reassemble once the pull tab 1408 has been removed and shows immediate evidence of tampering. Further, no further secure packaging or scratch off labeling is needed, thereby eliminating materials, while still resembling a secure CR80 card that a consumer is used to.

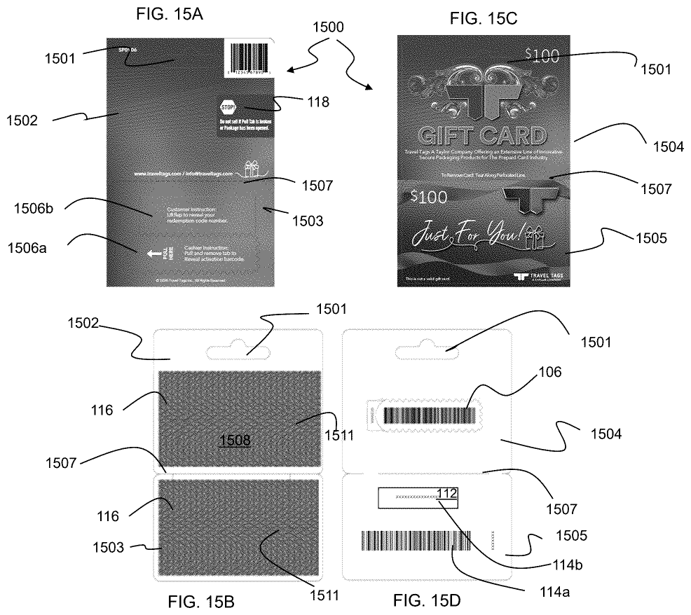

Referring to FIGS. 15A-15D, an exemplary embodiment of a stored value card assembly 1500 with tamper evident features is depicted. Assembly 1500 includes similar features to assembly 1400, including hanging aperture 1501 and snap-off portions 1503, 1505 separated from panels 1502, 1504, respectively, by perforations 1507. Activation indicia 106, such as a bar code, is printed or otherwise formed on an interior surface of front panel 1504, as shown in FIG. 15D, under pull tab 1508 formed in rear panel 1502. Assembly 1500 further includes a second pull tab assembly including pull tab 1506a formed in snap off portion 1503 which covers redemption data 114a, such as a redemption bar code, printed on or applied to panel 1505, with removable panel 1506b formed in snap off portion 1503 covering redemption field 112 having redemption data 114b, such as a PIN code, printed on or applied to portion 1505. Pull tabs 1506a, 1506b, and 1508 are formed as described with respect to the other assemblies, and are formed by kiss or score cuts 1511 (similar to kiss cuts 210 as described with respect to assembly 200, for example), In this example, pull tab 1508 obscures activation indicia 106 until pull tab 1508 is ruptured, and pull tab 1506a obscures redemption indicia 114a and connected panel 1506b obscures redemption indicia 114b in redemption field 112 until pull tab 1506a is ruptured and panel 1506b is lifted or removed. After assembly 1500 is activated, the top panels 1502 and 1504 can be removed, leaving the bottom snap-off portions 1503, 1505 as a giftable card.

As shown in FIG. 15B, an interior of both back panel 1502 and snap-off portion 1503 can include a blocking pattern 116 printed or otherwise applied thereon for further obscuring redemption indicia 114 and activation indicia 106. This eliminates the need for a scratch off layer formed over the redemption data 114 and/or activation indicia 106. An exterior surface of the back panel 1502, as shown in FIG. 15A, can further include tamper evident warnings, instructions, and/or other information printed or otherwise applied (e.g. label) thereto, on snap-off portion 1503 and/or the remaining portion of back panel 1502. For example, a tamper evident warning 118 can explain or warn that if the pull tab 1508 and/or tab assembly 1506 have been ruptured, the assembly 1500 may have been tampered with. As shown in FIG. 15C, an exterior surface of front panel 1504 can include any of a variety of text, graphics, information, such as, for example, the source of the card, the amount of a stored-value card, and/or any of a variety of indicia, on snap-off portion 1505 and/or the remaining portion of front panel 1504.

Assembly 1500 has the benefits of being impossible or extremely difficult to reassemble once the pull tab 1508 has been removed and shows immediate evidence of tampering. Further, no further secure packaging or scratch off labeling is needed, thereby eliminating materials, while still resembling a secure CR80 card that a consumer is used to.

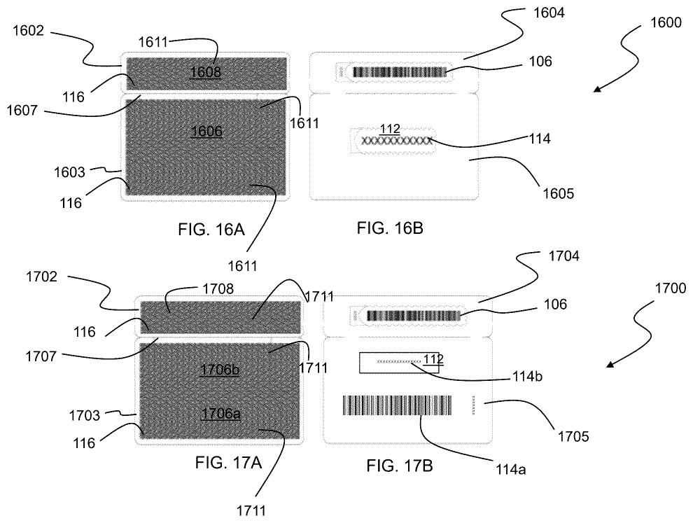

Referring to FIGS. 16A and 16B, an exemplary embodiment of a stored value card assembly 1600 with tamper evident features is depicted. Assembly 1600 includes similar features to assemblies 1400 and 1500, except that in this embodiment, snap-off activation portions 1602 and 1604 replace the larger upper panels. Activation panels 1602, 1604 are separated from snap-off panels 1603, 1605, respectively, by perforations 1607. Activation indicia 106, such as a bar code, is printed or otherwise formed on an interior surface of front activation panel 1604, as shown in FIG. 16B, under pull tab 1608 formed in activation panel 1602. Assembly 1600 further includes a second pull tab assembly including pull tab 1606 formed in snap off panel 1603 which covers redemption data 114, such as a PIN code, printed on or applied to panel 1605. Pull tabs 1606 and 1608 are formed as described with respect to the other assemblies, and are formed by kiss or score cuts 1611 (similar to kiss cuts 210 as described with respect to assembly 200, for example), In this example, pull tab 1608 obscures activation indicia 106 until pull tab 1608 is ruptured, and pull tab 1606 obscures redemption indicia until pull tab 1606 is ruptured. After assembly 1600 is activated, the top activation panels 1602 and 1604 can be removed, leaving the bottom snap-off panels 1603, 1605 as a giftable card.

As shown in FIG. 16A, an interior of both back activation panel 1602 and snap-off portion 1603 can include a blocking pattern 116 printed or otherwise applied thereon for further obscuring redemption indicia 114 and activation indicia 106. This eliminates the need for a scratch off layer formed over the redemption data 114 and/or activation indicia 106. Exterior surfaces of all the panels 1602, 1603, 1604, and 1605 can include any combination of tamper evident warnings, instructions, other information printed or otherwise applied (e.g. label) thereto, a variety of text, graphics, information, such as, for example, the source of the card, the amount of a stored-value card, and/or any of a variety of indicia, as described with respect to any of the other embodiments.

Assembly 1600 has the benefits of being impossible or extremely difficult to reassemble once the pull tab 1608 has been removed and shows immediate evidence of tampering. Further, no further secure packaging or scratch off labeling is needed, thereby eliminating materials, while still resembling a secure CR80 card that a consumer is used to.

Referring to FIGS. 17A and 17B, an exemplary embodiment of a stored value card assembly 1700 with tamper evident features is depicted. Assembly 1700 includes similar features to assembly 1600, except that in this embodiment, panel 1705 is similar to panel 1505 of assembly 1500. Activation panels 1702, 1704 are separated from snap-off panels 1703, 1705, respectively, by perforations 1707. Activation indicia 106, such as a bar code, is printed or otherwise formed on an interior surface of front activation panel 1704, as shown in FIG. 17B, under pull tab 1608 formed in back activation panel 1602. Assembly 1700 further includes a second pull tab assembly including pull tab 1706a formed in snap off portion 1703 which covers redemption data 114a, such as a redemption bar code, printed on or applied to panel 1705, with removable panel 1706b formed in snap off portion 1703 covering redemption field 112 having redemption data 114b, such as a PIN code, printed on or applied to panel 1705. Pull tabs 1706a, 1706b, and 1708 are formed as described with respect to the other assemblies, and are formed by kiss or score cuts 1711 (similar to kiss cuts 210 as described with respect to assembly 200, for example), In this example, pull tab 1708 obscures activation indicia 106 until pull tab 1708 is ruptured, and pull tab 1706a obscures redemption indicia 114a and connected panel 1706b obscures redemption indicia 114b in redemption field 112 until pull tab 1706a is ruptured and panel 1706b is lifted or removed. After assembly 1700 is activated, the top activation panels 1702 and 1704 can be removed, leaving the bottom snap-off panels 1703, 1705 as a giftable card. As shown in FIG. 17B, an interior of both back activation panel 1702 and snap-off portion 1703 can include a blocking pattern 116 printed or otherwise applied thereon for further obscuring redemption indicia 114 and activation indicia 106. This eliminates the need for a scratch off layer formed over the redemption data 114 and/or activation indicia 106. Exterior surfaces of all the panels 1702, 1703, 1704, and 1705 can include any combination of tamper evident warnings, instructions, other information printed or otherwise applied (e.g. label) thereto, a variety of text, graphics, information, such as, for example, the source of the card, the amount of a stored-value card, and/or any of a variety of indicia, as described with respect to any of the other embodiments.

Assembly 1700 has the benefits of being impossible or extremely difficult to reassemble once the pull tab 1708 has been removed and shows immediate evidence of tampering. Further, no further secure packaging or scratch off labeling is needed, thereby eliminating materials, while still resembling a secure CR80 card that a consumer is used to.

In any or all embodiments, the card assemblies and/or cards can be manufactured by sheet-fed or web-based processes. For example, the card assemblies and/or cards can be printed, embedded, or encoded with human- and/or machine-readable indicia, adhesive, heat activated inks or coating, either inline via one or more web processes or sheet processes. For example, the carriers and/or cards can be printed with human- and/or machine-readable indicia and/or adhesives using web-based digital printing processes, such as ink jet, or non-digital printing processes, cured with curing processes (e.g. air, heat, UV, IR, etc.), assembled or secured via pressure processes (pressure sealing processes), converted using converting processes (e.g. cutting into individual packs), embedded or encoded with RFID/NFC chips and/or magnetic stripes, packaged or any of a variety of known processes to one of ordinary skill in the art. In the event of an NFC label, the data is accessible on a mobile device that points or links to a URL with the data thereon. These processes can be accomplished via a single web-based system, or a combination of web-based systems. Examples of methods and equipment are described, for example, in the following patents, each of which is incorporated by reference herein in its entirety: U.S. Pat. Nos. 10,007,875; 9,527,333; 9,881,249; and 7,537,158; and Canadian patent application No. 2,814,938.

Various examples of assemblies, devices, and methods have been described herein. These examples are given only by way of example and are not intended to limit the scope of the claimed inventions. It should be appreciated, moreover, that the various features of the examples that have been described may be combined in various ways to produce numerous additional examples. Moreover, while various materials, dimensions, shapes, configurations and locations, etc. have been described for use with disclosed examples, others besides those disclosed may be utilized without exceeding the scope of the claimed inventions.

Persons of ordinary skill in the relevant arts will recognize that the subject matter hereof may comprise fewer features than illustrated in any individual embodiment described above. The examples described herein are not meant to be an exhaustive presentation of the ways in which the various features of the subject matter hereof may be combined. Accordingly, the examples are not mutually exclusive combinations of features; rather, the various examples can comprise a combination of different individual features selected from different individual examples, as understood by persons of ordinary skill in the art. Moreover, elements described with respect to one embodiment can be implemented in other examples even when not described in such examples unless otherwise noted.

Although a dependent claim may refer in the claims to a specific combination with one or more other claims, other examples can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

What is claimed is:

1. A card assembly comprising:
a first panel;
a second panel coupled to the first panel, and second panel having at least one pull tab formed therein, and having a light blocking layer applied to an interior surface of the second panel;
activation indicia applied to one of the first and second panels and configured to activate the card assembly; and
redemption indicia applied to an interior surface of the first panel, the redemption indicia configured to allow a user to redeem or access an account associated therewith;
wherein the pull tab is configured to be ruptured to access the redemption indicia, and
wherein the card assembly is configured to indicate tampering.

2. The card assembly of claim 1, wherein the first panel and second panel are discrete panels or foldable panels coupled via an adhesive, wherein the adhesive is applied to the panels such that the adhesive bleeds off an entirety of a perimeter of the card assembly.

3. The card assembly of claim 2, wherein the adhesive comprises a pressure sensitive adhesive, high solids water-based cold glue, or a water-based pressure seal coating.

4. The card assembly of claim 1, wherein the card assembly includes a heat tampering coating formed on an exterior of the assembly, the heat tampering coating being configured to undergo a color change upon application of heat to indicate potential tampering.

5. The card assembly of claim 1, wherein the card assembly includes a chemical tampering coating formed on an exterior of the assembly, the chemical tampering coating being configured to undergo a color change upon application of a solvent to indicate potential tampering.

6. The card assembly of claim 1, wherein the pull tab is formed via kiss cuts on an interior surface of the second panel such that the kiss cuts are not visible on an exterior surface of the second panel.

7. The card assembly of claim 1, wherein the activation indicia is coupled to or printed on an interior surface of the first panel, and wherein the second panel includes a second pull tab configured to be ruptured to access the activation indicia.

8. The card assembly of claim 1, wherein the activation indicia is coupled to or printed on an exterior surface of the second panel.

9. The card assembly of claim 1, wherein the pull tab includes a tamper evident label or a tamper evident graphic over at least a portion thereof.

10. The card assembly of claim 1, wherein the first panel and the second panel each include a top portion and a snap-off portion coupled to the top portion on a bottom edge thereof, the snap-off portions being removable from the top portions upon activation, thereby forming a giftable card.

11. The card assembly of claim 10, wherein activation indicia is applied to an interior surface of the top portion of the first panel.

12. The card assembly of claim 1, wherein redemption data of the redemption indicia is stored on an NFC label positioned between the first and second panels, and is accessible on a mobile device that points or links to a URL for the redemption data.

13. The card assembly of claim 1, wherein the redemption indicia comprises a barcode, a PIN code, or both.

14. A card assembly comprising:
a first panel;
a second panel coupled to the first panel, and second panel having at least one pull tab formed therein, and having a light blocking layer applied to an interior surface of the second panel, wherein the first and second panels are secured by an adhesive that is applied such that the adhesive entirely surrounds a perimeter of the panels up to and including edges thereof; and
redemption indicia applied to an interior surface of the first panel, the redemption indicia configured to allow a user to redeem or access an account associated therewith;
wherein the pull tab comprises kiss cuts formed on an interior surface of the second panel such that the kiss cuts are not visible on an exterior surface of the second panel, and
wherein the pull tab is configured to be ruptured to access the redemption indicia.

15. The card assembly of claim 14, wherein the adhesive comprises a pressure sensitive adhesive, high solids water-based cold glue, or a water-based pressure seal coating, or combinations thereof.

16. The card assembly of claim 14, further comprising activation indicia applied to one of the first and second panels and configured to activate the card assembly.

17. The card assembly of claim 16, wherein the activation indicia is coupled to or printed on an interior surface of the first panel.

18. The card assembly of claim 16, wherein the activation indicia is coupled to or printed on an exterior surface of the second panel.

19. The card assembly of claim 14, wherein the pull tab includes a tamper evident label or a tamper evident graphic over at least a portion thereof configured to warn a user that the card assembly may have been tampered with if the pull tab is ruptured.

20. The card assembly of claim 14, wherein the first panel and the second panel each include a top portion and a snap-off portion coupled to the top portion on a bottom edge thereof, the snap-off portions being removable from the top portions upon activation, thereby forming a giftable card.

21. The card assembly of claim 20, wherein activation indicia is applied to an interior surface of the top portion of the first panel, and wherein the top portion of the second panel includes a second pull tab configured to be ruptured to access the activation indicia.

22. The card assembly of claim 14, wherein the redemption indicia comprises a barcode, a PIN code, or both.

23. The card assembly of claim 14, wherein redemption data of the redemption indicia is stored on an NFC label positioned between the first and second panels, and is accessible on a mobile device that points or links to a URL for the redemption data.
